(19) United States
(12) Patent Application Publication
(10) Pub. No.: US 2002/0045727 A1
(43) Pub. Date: Apr. 18, 2002

(54) Method for producing methylene urea polymers

(76) Inventors: Hartmut Weyer, Kerpen (DE); Detlef Schneider, Dudweiler (DE); Ulrike Planta, Forbach (FR); Esther Barthel, Saarbruecken (DE)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 09/956,864

(22) Filed: Sep. 20, 2001

(30) Foreign Application Priority Data
Sep. 21, 2000 (EP) 00 120 664.8

(51) Int. Cl. C08G 12/12; C08G 12/32

(52) U.S. Cl. 528/259; 528/254; 528/230; 528/491; 528/503; 264/45.9; 264/45.1

(57) ABSTRACT

The invention relates to a method for producing methylene urea polymers using urea, a formaldehyde product and a reactant, such as an acid. Urea is introduced into a multi-screw extruder together with the formaldehyde product. In the extruder the products are mixed, compressed, heated and melted to a flowable mixture. A reactant, such as an acid is added to the melted mixture, thereby forming a mass having methylene urea polymers. The mass is extruded afterwards.

### FIELD OF THE INVENTION

The invention relates to a method for producing methylene urea polymers using at least urea, a formaldehyde product as well as a reactant.

### BACKGROUND OF THE INVENTION

In the production of fertilizers, urea is of particular importance. It contains a high proportion of nitrogen and can be produced at low cost. However, it is rather uneconomical to use pure urea as fertilizer because pure urea washes out easily and is highly volatile.

It is known to employ urea in a compound with formaldehyde as fertilizer. In this compound, which is also referred to as methylene urea, the above described negative properties of urea are avoided to a large extent.

A method according to the preamble for producing methylene urea results for example from DE-PS 24 22 238. In accordance with one embodiment free urea is at first adjusted with a mineral acid to a particular pH-value in a stirrer vessel. In the next step, a pre-condensate consisting of urea and formaldehyde is added while a particular temperature has to be kept over a longer period of time. After completing the reactions for the production of the intended product condensate, this condensate is approximately neutralized in a subsequent method step by adding alkali. In an additional step, a filtration is then carried out. While the filtrate is lead into the reaction vessel again, the moist condensate is dried and processed to the desired end product.

This known method requires great expenditure regarding both the apparatus needed and the time involved.

### SUMMARY OF THE INVENTION

The Invention is based on the object to provide a method for producing methylene urea, which can be carried out in a quick as well as simple and therefore cost-effective manner.

In accordance with the invention, the object is solved by a method according to claim 1. Advantageous embodiments of the invention become apparent from the dependent claims. The present invention discloses a method for producing methylene urea polymers using at least urea, a formaldehyde product, and a reactant, comprising introducing urea with a formaldehyde product into a first section of a multi-screw extruder area; mixing and compressing said urea and said formaldehyde product in said first section of the extruder; heating and melting said urea and said formaldehyde product in said first section of the extruder; transporting said melted urea and said formaldehyde product from said first section of the extruder to a subsequent section of said extruder; reacting said melted urea and said formaldehyde product with a rectant to form a mass having methylene urea polymers; and extruding said mass having methylene urea polymers.

### BRIEF DESCRIPTION OF THE DRAWINGS

FIG. 1 shows a schematic illustration of an embodiment of the present invention useful in producing methylene urea polymers.

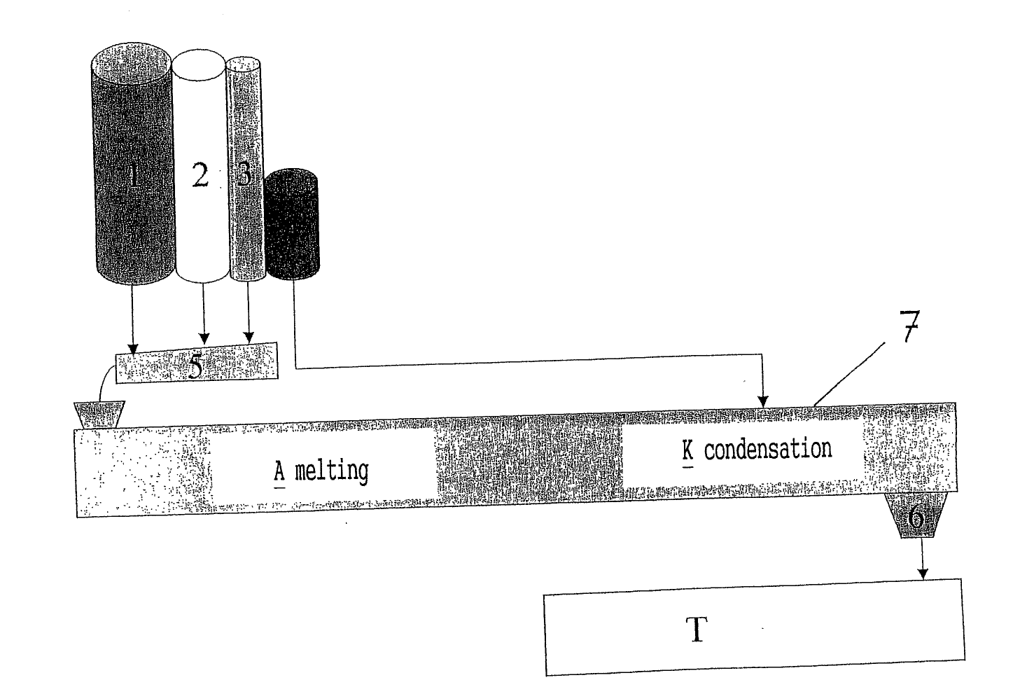

### DETAILED DESCRIPTION OF THE INVENTION

In accordance with the invention, the object is solved by a method according to claim 1. Advantageous embodiments of the invention become apparent from the dependent claims. The present invention discloses a method for producing methylene urea polymers using at least urea, a formaldehyde product, and a reactant, comprising introducing urea with a formaldehyde product into a first section of a multi-screw extruder area; mixing and compressing said urea and said formaldehyde product in said first section of the extruder; heating and melting said urea and said formaldehyde product in said first section of the extruder; transporting said melted urea and said formaldehyde product from said first section of the extruder to a subsequent section of said extruder; reacting said melted urea and said formaldehyde product with a rectant to form a mass having methylene urea polymers; and extruding said mass having methylene urea polymers.

In this way the entire method can be carried out in a continuous fashion in one single device. Moreover, since the process area is enclosed by the extruder housing an undesired escape of reaction intermediates, for example of ammoniac, is avoided to a large extent. For the production of methylene urea the individual reaction products are fed into the extruder at a high dosing precision. The mixing of urea with the formaldehyde product in the multi-screw extruder leads, upon interaction with the compression and the simultaneous heating, to a very homogenous melt. This is in turn an essential precondition for the fact that when the acid is also fed at a high dosing precision and when being thoroughly mixed, a quick and almost complete reaction of the starting products leads to the desired methylene urea polymers. The use of a multi-screw extruder having at least two screws, which can be driven synchronously or in counter-rotation, is of particular importance here. For it is only the interaction of meshing extruder screws that leads to a large reaction surface between the starting products. This is a precondition for an almost complete reaction.

As a result of the precise dosage of the starting products in a continuous process and due to an almost free possibility of choosing the reaction parameters with regard to mixing, temperature, compression, reaction times, etc., it is rendered possible for the first time with the method according to the invention to adjust at high precision the result of the reaction with respect to the chain length of the produced polymers. Thus, methylene urea can be produced as desired with a high proportion of short-chain methylene urea polymers, such as methylenediurea or dimethylenetiurea, or with a high proportion of long-chain polymers, such as trimethylenetetraurea, tetramethylenepentaurea etc.

Compared to the prior art know so far, the method according to the invention therefore not only offers advantages with respect to a compact, low-cost device as well as a quick performance of the method but also with respect to the production of a plurality of precisely defined end products.

For the purpose of performing the method in a particularly effective way, it has proved to be of advantage that paraformaldehyde is used as formaldehyde product.

A further increase in efficiency of the method performance is achieved in accordance with the invention in that hexamethylenetetramine and/or tetramethylenediamine is introduced into the extruder together with urea and the formaldehyde product and melted to the mixture. With this an altogether dehydrated process can be achieved such that a drying process can be dispensed with or can at least be drastically reduced.

For the final reaction to produce methylene urea almost any common reactant, such as an acid, can be employed. With regard to the costs and the reaction safety, it is of advantage to use as acid phosphoric, hydrochloric and/or sulphuric acid as a reactant.

In principle, the melting of the mixture in the first extruder section can be effected merely by the frictional heat that develops as a result of the transport and the compression of the reaction products. However, for a gentle and at the same time quick heating, it is provided in accordance with the invention that the heating of the mixture in the first extruder section is effected by using heating elements on the extruder. The heating elements can be electric heating coils or heating water pipes disposed inside or on the extruder housing along a particular heating section. In this way any desired heating temperature as well as a purpose-directed temperature control can be adjusted in a simple way. For the melting of the mixture the preferred temperature range lies between 60° C. and 120° C. However, higher or lower temperatures can also be chosen for particular method variants.

A particularly preferred embodiment of the method according to the invention resides in that an active substance, such as another fertilizer, a plant protective, a growth regulator etc. is additionally introduced into the extruder and incorporated into the mass consisting of methylene urea polymers. It is useful to feed the supplementary active substance after feeding the acid and after the reaction of methylene urea has been largely completed. With the active substance used together with methylene urea, a combined fertilizer or another combined preparation can thus be produced in the same method step and in the same device. Particularly in the very price-sensitive market segment of fertilizers this leads to definite economic advantages.

Since the mixture of substances and the mass still is in a melted state, the additional active substances can be introduced at the precise dosage through a so-called side feeder or another suitable feeding device and processed in the extruder to a homogenous mass. In this way, a complex combination fertilizer or preparation can be produced without any intermediate product and the transportation and storage processes that are otherwise involved therewith. Furthermore, the feeding of the additional active substances into the still liquid or flowable mass of methylene urea polymers has the further advantage that the additional active substances can in incorporated without any binding agent. Consequently, a fertilizer can be produced on the basis of methylene urea with additional active substances, which fertilizer can be absorbed by the plants without leaving any residues in an ecologically and economically appropriate manner. When feeding nitrogen, phosphor and/or kali fertilizer salts it is preferred in certain cases to additionally inject water into the extruder together with the active substance in order to ensure a good dissolution of the nutrient salts and a good mixing and blending with methylene urea.

According to the invention, it is furthermore preferred to lead the mass through a forming tool and/or a granulating tool on the exit of the extruder. In doing so, the end product can be adjusted as to size and shape immediately upon the exit of the mass from the extruder. Afterwards, a short drying period and, if needed, a rounding of the granulated material is required at the most.

As far as the drying is concerned, it is preferred that the mass is dried by means of a drying device following the exit from the extruder. This can be a rotary furnace or a conveyer belt which runs along heating elements.

Another preferred variant of the method according to the invention is that the proportions of the methylene urea polymers having a different chain length are adjusted relative to each other in a defined manner by controlling the feeding of the individual substances into the extruder. The control can be directed at both a quantitative and a qualitative change of the feeding components. As feeding devices side feeder pumps, dosing pumps etc., driven by controllable electromotors, or controllable valves can be provided on feeding vessels or feeding lines. The feedings can be controlled in their entirely by a controlling computer such that desired produce changes or product variants can be adjusted from a central station in a simple and quick way.

An acid salt may also be employed as a reactant instead of using an acid. For example, ammonium sulphate is a good donor or H⁺ ions.

Where the quantitative composition is concerned, the method can be carried out with respect to 100 weight percent of methylene urea produced, using 50%-90% urea, 40%−5% formaldehyde product. 10%−0% hexamethylenetetramine as well as a remainder of reactant. By deliberately changing the proportions the chain length of the polymers and their proportions relative to each other can be adjusted which can be easily established by tests.

In the following, a detailed description of the invention is given with reference to a preferred embodiment, a diagrammatic view of which is shown in the only Figure.

This single Figure shows a diagrammatic arrangement of a device for performing the method in accordance with the invention.

This device comprises a multi-screw extruder 7 which is preferably driven in counter-rotation. In a first vessel 1, there is urea which is lead to a weighing belt 5 together with pararomaldehyde from another vessel 2 as well as hexamethylenetetramine from a different vessel 3. The weighing belt 6 serves as a dosing device to compose the aforementioned starting products in a precise quantitative way.

The aforementioned starting products are introduced over the weighing belt 5 into an inlet of the extruder 7.

In a first section A of the extruder 7 urea, paraformaldehyde and hesamethylenetetramine are mixed with each other, compressed and melted as a result of the frictional heat present in the extruder 7 and due to a heating capacity of heating elements that are not depicted. The melting temperature of the mixture lies between 60 C. and 90° C.

The mixture melted in this way is lead in the course of the extruder 7 to another section K of the extruder 7 in which a reactant, such as phosphoric acid, is added to the melted mixture from an acid vessel 4. The liquid reactant is injected into the extruder 7 through an injection device, which is not illustrated in detail, such that in combination with the mixing effect of the two extruder screws a good mixing of the reaction products and thus a high reaction surface is achieved. In this way a quick and practically complete condensation to methylene urea can take place. After the reaction zone inside the extruder 7 the mass is cooled down and, upon reaching a particular solidity, is extruded at the exit of the extruder 7 through a forming tool 6.

Depending on the consistency of the produced mass and the desired end product a granulating device may be provided on the forming tool 6, which device cuts the extruded strands to a desired length. The extruded material is lead over a belt-shaped drying device T where it is dried to a desired degree. Following the drying step the end product can in addition be rounded for particular applications or directly filled and thus be prepared for dispatch.

In one embodiment of the method, the mass is composed of 80% urea, 13% paraformaldehyde, 3% hexamethylenetetramine as well as 4% phosphoric acid.

From the explanations set out above, it becomes apparent that a particularly simple, cost-effective and yet still very precise method for producing methylene urea is provided by the method according to the invention.

We claim as follows:

1. A method for producing methylene urea polymers using at least urea, a formaldehyde product as well as a reactant, comprising:
introducing urea with a formaldehyde product into a first section of a multi-screw extruder area;
mixing and compressing said urea and said formaldehyde product in said first section of the extruder;
heating and melting said urea and said formaldehyde product in said first section of the extruder;
transporting said melted urea and said formaldehyde product from said first section of the extruder to a subsequent section of said extruder;
reacting said melted urea and said formaldehyde product with a reactant to form a mass having methylene urea polymers; and
extruding said mass having methylene urea polymers.

2. The method of claim 1, further comprising employing paraformaldehyde as said formaldehyde product.

3. The method of claim 1, further comprising introducing hexamethylenetetramine into the first section of said extruder together with said urea and said formaldehyde product.

4. The method of claim 1, further comprising introducing
tetramethylenediamine into the first section of said extruder together with said urea and said formaldehyde product.

5. The method of claim 1 wherein said reactant comprises an acid.

6. The method of claim 5 wherein said acid comprises Phosphoric acid.

7. The method of claim 5 wherein said acid comprises Hydrochloric acid.

8. The method of claim 5 wherein said acid comprises Sulfuric acid.

9. The method of claim 1 wherein said reactant comprises an acid salt.

10. The method of claim 9 wherein said acid salt comprises ammonium sulphate.

11. The method of claim 9 wherein said acid salt comprises a substance with an acid reaction.

12. The method of claim 1, further comprising using heating elements is communication with the first section of said extruder to heat said urea and said formaldehyde product.

13. The method of claim 1, further comprising introducing an active substance into said extruder and incorporating said active substance into said mass consisting of methylene urea polymers.

14. The method of claim 13 wherein said active substance is another fertilizer.

15. The method of claim 13 wherein said active substance is a plant protective regulator.

16. The method of claim 13 wherein said active substance is a plant growth regulator.

17. The method of claim 1, further comprising advancing said mass through a forming tool in communication with said extruder.

18. The method of claim 1, further comprising advancing said mass through a granulating tool in communication with said extruder.

19. The method of claim 1, further comprising drying said mass with a drying means.

20. The method of claim 1, further comprising adjusting a feed rate of said urea and said formaldehyde product thereby controlling a chain length of said methylene urea polymers relative to each other.
